(19) United States
(12) Patent Application Publication
(10) Pub. No.: US 2009/0199773 A1
(43) Pub. Date: Aug. 13, 2009

(54) Quick converter dispenser

(76) Inventor: Scott Jurk, (US)

Correspondence Address: Scott Jurk, 402 San Gabriel Blvd, Georgetown, TX, 78628, US

(21) Appl. No.: 12/069,387

(22) Filed: Feb. 11, 2008

(51) Int. Cl. A01K 5/00

(52) U.S. Cl. 119/57.91; 248/213.2

(57) ABSTRACT

This invention is an apparatus that will allow the conversion of feeders of the prior art to be converted to feeders that feed a controlled amount onto a plate that keeps feed off of the ground, and converted back again without having to remove the existing motor and spinner of the prior art. There are many people who use spinning distributors to feed grain to wildlife. Many of these persons would like to keep the grain off of the ground and feed specialized pelleted feeds that can dissolve on the ground. This device allows these people to use this apparatus with existing spin type feeders, but to also convert them into a multi purpose unit and back again in seconds with out modification to the existing spin unit.

This device consists of a mounting ring with integral lock design that mounts to the existing feed container and around the spin type distributor. This mounting ring consists of two pieces of material that have integral slotting and are manufactured together to for one piece to lock the dispenser portion in place. This mounting ring does not have to be removed to allow for use of the spin type distributor in its current state.

This device also includes a distributing tube that consist of a body that attaches to the mounting ring and is used to catch feed coming from the spin type distributor and funnel it into the distribution tube on the is device. The catching bin has integral tabs that allow it to fit into the mounting ring and to lock in place by twisting in the prescribed manner. This allows the distributor to be installed and removed in seconds with out removing the mounting ring or the spin type distributor.

The distribution tube runs from the body to the feeding plate where the grain or feed is consumed by the animal. This feeding plate is attached to the distribution tube in such a manner that the plate is adjustable to allow for leveling of the feeding plate in multiple directions this allows for use in uneven areas. The feeding tube also has water drain holes in the event that water would concentrate on the feeding plate. The plate can also be adjusted to allow for the proper rate of feed that is desired by the user. This invention will be more fully explained in the drawings that follow.

### BACKGROUND AND PURPOSE

The purpose and need for this invention is to convert spin type feeding distributors that most hunters use to attach and feed game. To a multipurpose type feeder that can be used during certain times of the year to feed specialized protein feeds that can not be properly fed on the ground. The existing spin type distributors would through this on the ground where it would dissolve or be wasted. Also exposure to weather while on the spin type distributor can cause clogging of the distributor resulting in no feed is dispensed. The user does not feed these special feeds year round so during the hunting portion of the year he wants the grain to be scatted on the ground. Currently you can purchase a spin type distributor or a gravity type distributor that will not let feed touch the ground. However to convert from one to the other requires a complete change of the distributing apparatus and feed can not be regulated in the gravity feed application. The two feed distributors can not be used simultaneously.

With this new distribution method the hunter can use the invention to dispense feed based on his needs and can meter the amount of feed that is fed. The hunter can change from spin to gravity distribution in seconds and with out having to remove his spin distributor. When the hunter is ready he can remove the gravity distributor in seconds and the mounting ring stays in place. He also will need no tools and can do this while the container is still fill of feed. This fulfils the need of the user with out the complete removal of one distributor to attach another distributor. This distributor also allows the user to keep feed off the ground during wet seasons and to keep it away from non-targeted species.

### DESCRIPTION

In the drawings:

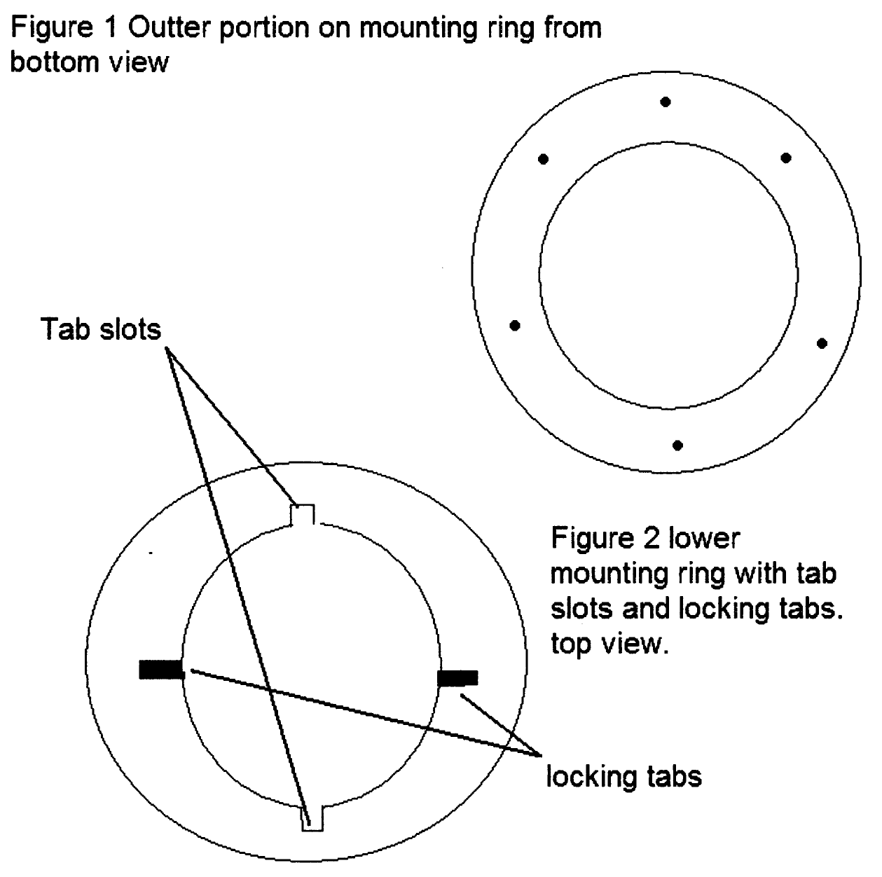

FIG. 1 and 2:

These figures show the mounting plate broken down to show unique features of each part. The upper ring FIG. 1 shows the mounting holes that are on the outer edge of the mounting plate and are used to mount to plate to the feeder receptacle and is placed around the existing spin distributor. The lower ring in FIG. 2 shows the tab openings in which the dispenser attachment tabs go through and are then turned and secured by the locking tabs. This ring supports the dispenser attachment tabs and thus the dispenser itself. It prevents accidental removal of the dispenser. The rings are manufactured as one unit and are split here only for illustration and description.

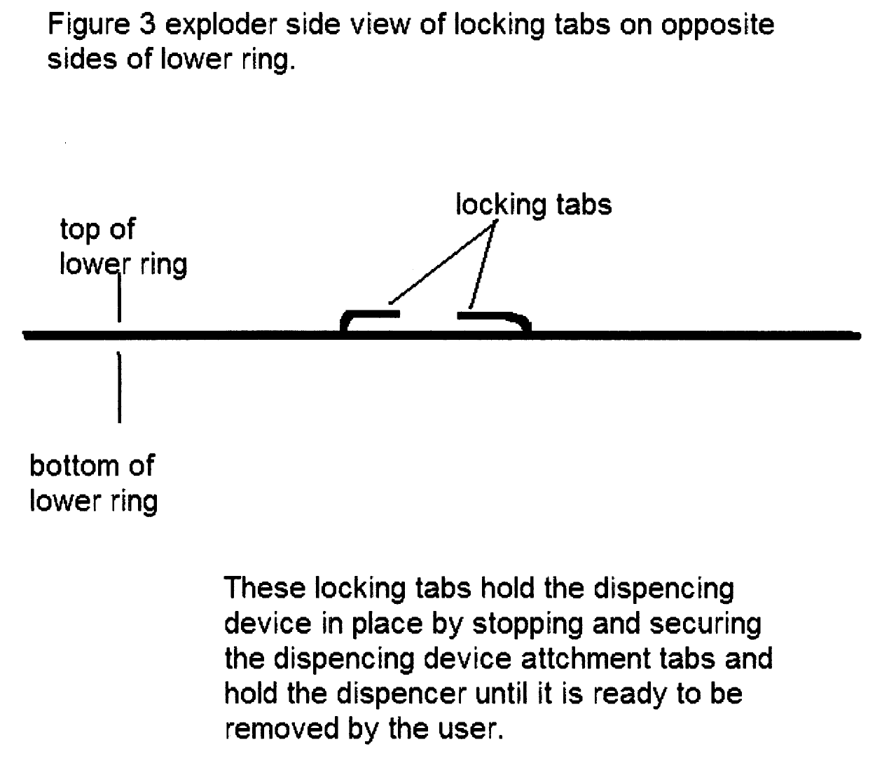

FIG. 3:

This is an exploded side view of the locking tabs that are manufactured in such a way to stop and snuggly hold the dispenser attachment tabs in the proper position. 4

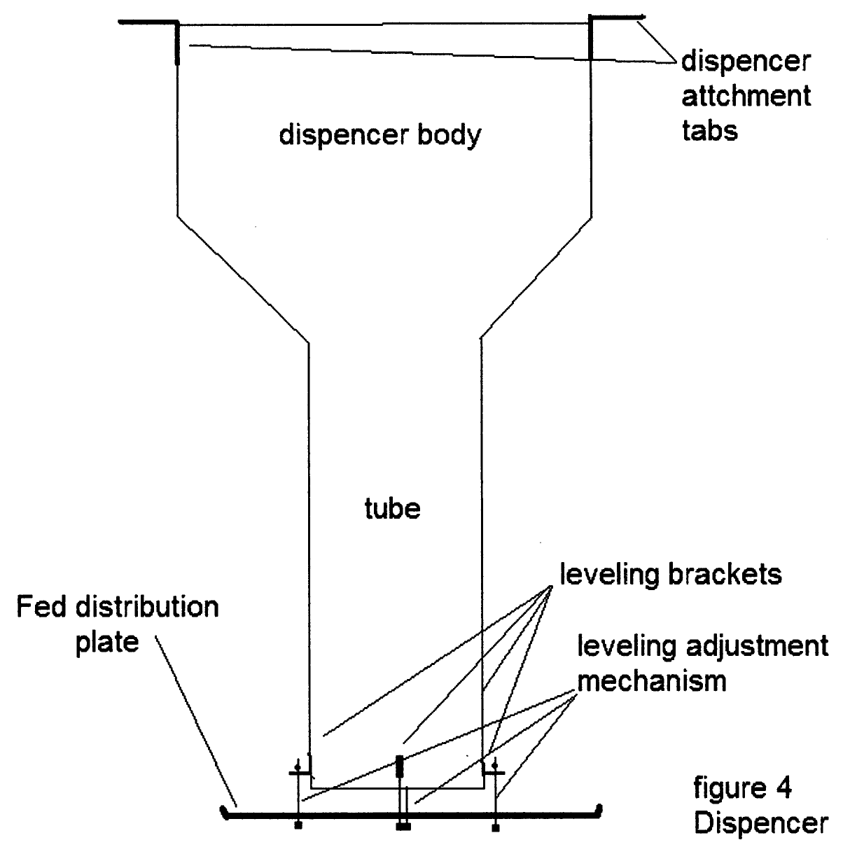

FIG. 4:

This shows the features of the dispenser portion of the invention. The attachment tabs fit into the mounting ring and lock in place to support the dispenser. The body of the dispenser catches the feed distributed by the spin type distributor. The feed is funneled into the tube of the dispenser. The tube is the transporting and holding mechanism for the feed. The feed falls to the feed plate. The feed plate is held by the leveling mechanisms and is designed to drain water through holes in the plate. The leveling mechanism allows for vertical adjustment of the feed plate not only to regulate the amount of feed accessible to the animal but also to level the plate if the receptacle is placed on uneven ground. The leveling apparatus are strategically placed to allow for multiple adjustment options.

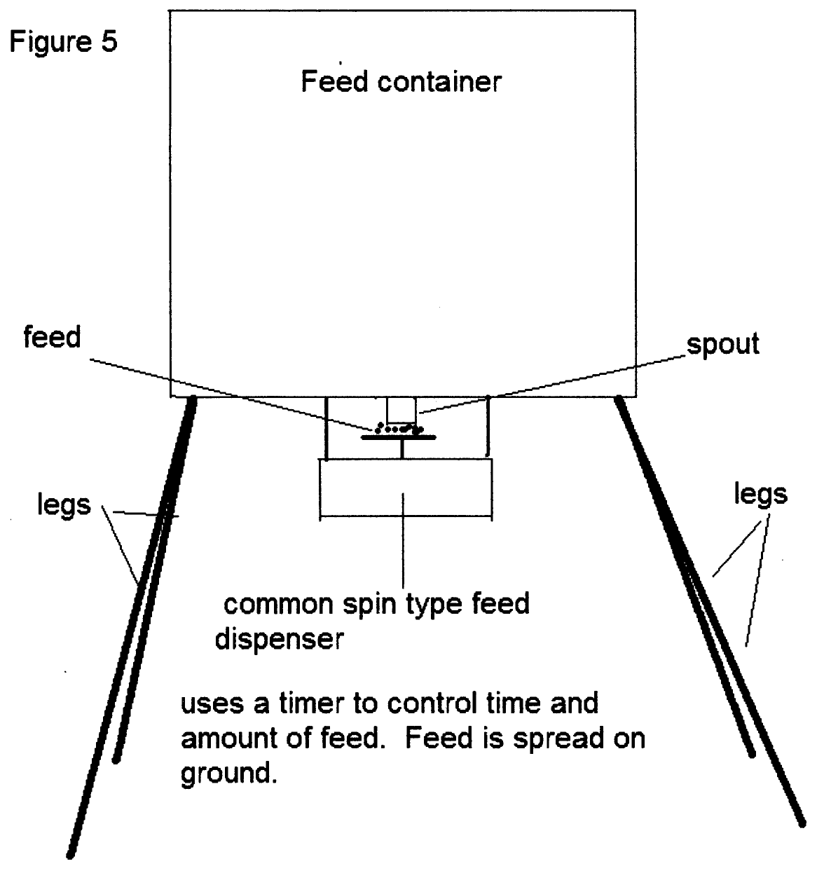

FIG. 5:

Depicts the normal spin feeder of the prior art which spreads feed on the ground.

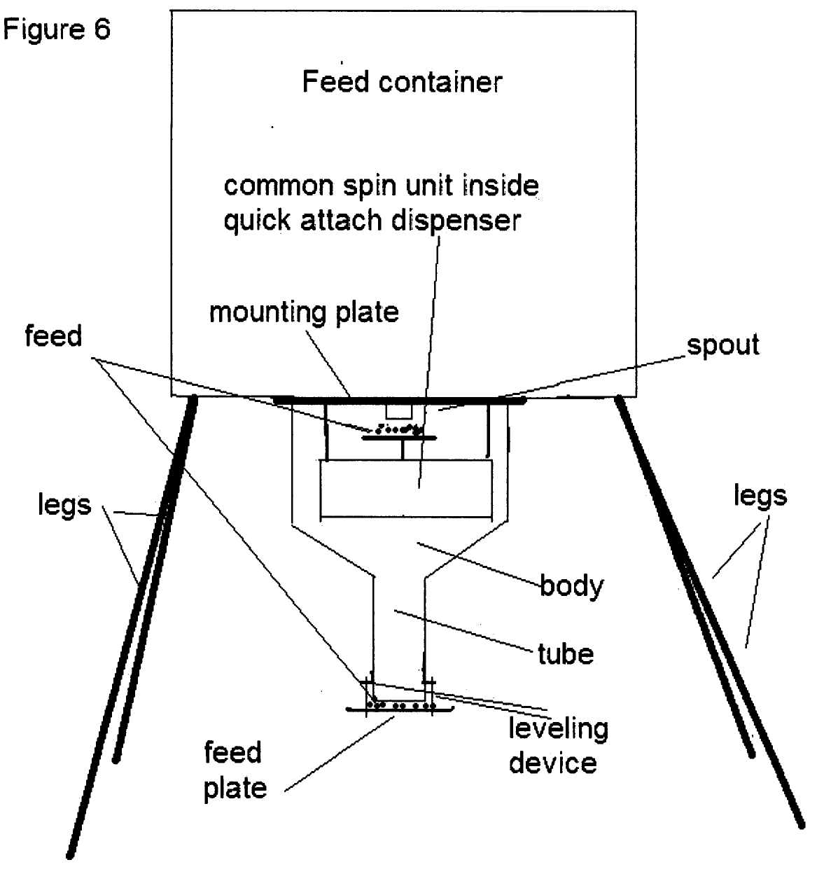

FIG. 6:

The dispenser of this invention shown with a see through view placed over the spin feeder of the prior art. 5

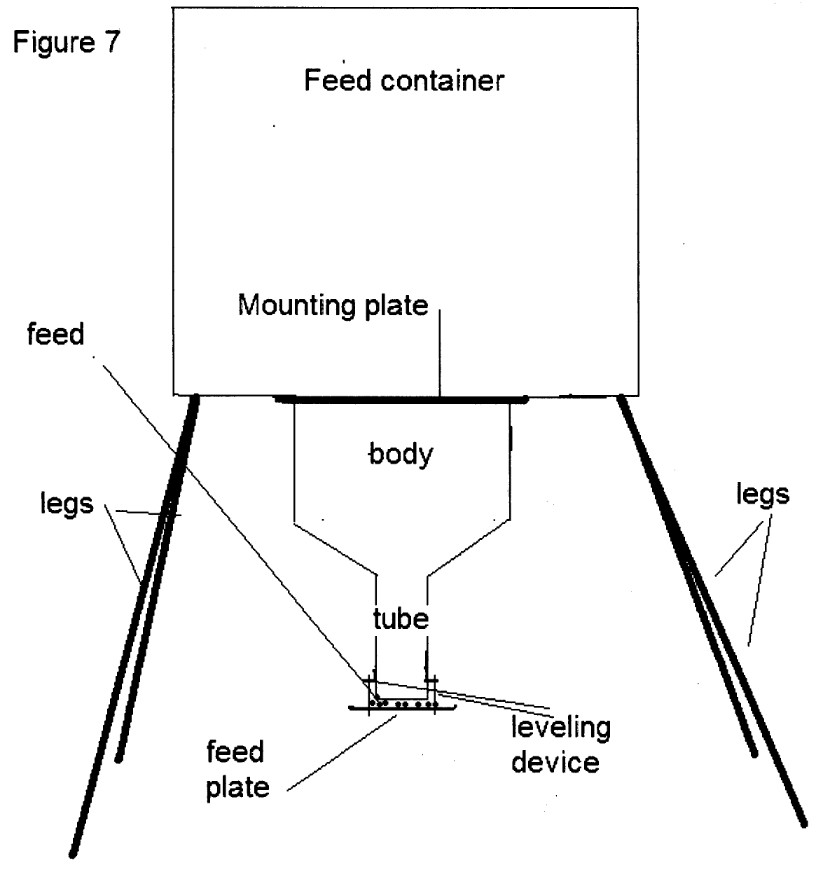

FIG. 7

Depicts the view of the dispenser in place over the spin feeder of the prior art.

I claim

1. A mounting ring consisting of outer holes that are used in attaching the mounting ring to the receptacle around the existing distributor. The same mounting ring having integral openings for the attachments tabs of the dispenser in claim 2. The mounting ring also including an integrated locking system that hold the dispenser in claim 2 in the proper position and allows for easy removal.

2. A dispenser consisting of integral attachment tabs that fit into the openings in the mounting ring of claim 1 and support the dispenser and allow for locking of the dispenser in the proper location. The same dispenser having a body to catch the feed material and distribute it into the tube which facilitates the feed to the feed plate of claim 3.

3. A feed plate consisting of a plate with mounting holes and hole for adjustment mechanism of claim 4.
Also having upturned edges as to facilitate the stoppage of fed falling down the tube. The said plate which is level able by the use of the leveling mechanism of claim 4.

4. I leveling mechanism consisting of attachment brackets attached to the tube of claim 2 and adjustable rods extending down and through the feed plate of claim 3. Each individually adjustable to allow for leveling of the feed plate of claim 3 even if the receptacle is not level. Thus preventing the loss of feed.
